(19) United States
(12) Patent Application Publication
(10) Pub. No.: US 2024/0199276 A1
(43) Pub. Date: Jun. 20, 2024

(54) A DRONE TRANSPORTABLE MULTI-COMPARTMENT CONTAINER AND A DRONE COMPRISING THE SAME

(71) Applicant: YAPE S.R.L., Milano (MI) (IT)

(72) Inventors: Simone FIORENTI, Milano (MI) (IT); Enrico ZATTI, Zone (BS) (IT)

(73) Assignee: YAPE S.R.L., Milano (MI) (IT)

(21) Appl. No.: 18/555,992

(22) PCT Filed: Apr. 15, 2022
(86) PCT No.: PCT/IB2022/053568

§ 371 Date: Oct. 18, 2023

(30) Foreign Application Priority Data
Apr. 19, 2021 (IT) 102021000009800

(51) Int. Cl. B65D 25/04; B60P 3/00; B65D 55/02; G07C 9/00

(52) U.S. Cl. CPC B65D 25/04; B60P 3/00; B65D 55/02; G07C 9/00182; G07C 9/00563; G07C 2009/00206

(57) ABSTRACT

A multi-compartment storage container for a drone is disclosed having a housing defining a main compartment, a plurality of separation walls designed to delimit from each other internal compartments which are contained inside the main compartment, closing assemblies associated with an internal compartment operable to be switched between a locked configuration which prevents access to the internal compartment, and an unlocked configuration which allow access to the internal compartment. A control device is also provided being connected to the closing assemblies allowing them to operate selectively and equipped with an interface configured to receive an identification signal from a user. If the identification signal is associated with a predefined access authorization a selected internal compartment associated with the predefined access authorization is unlocked.

### TECHNICAL SECTOR

The present invention relates to a multi-compartment storage container transportable by a drone for the delivery of products and drone comprising said container. In particular, the present invention relates to a multi-compartment storage container with selective access, namely where each compartment may be associated with a specific recipient who will have access to only the compartment(s) associated with said recipient.

The present multi-compartment storage container may also allow adaptation of the compartments to the shape and size of the products to be housed inside them.

### PRIOR ART

Nowadays drones have started to be developed for the automated delivery of small products, i.e. products which, for example, may have dimensions comparable to 50×50×50 cm and in particular equivalent to 42×38×31 cm.

These drones are provided with a compartment for housing a package to be delivered or have a portion configured for fixing said package therein.

They have been developed to navigate in a completely independent manner owing to path planification algorithms based on information acquired by high-precision sensors, typically Lidar sensors and video cameras. Once the destination has been reached, various systems such as face scanners, QR codes, alphanumeric combinations, etc., allow identification of the user who requires access to the transportation compartment, i.e. a check that said user corresponds to the predefined recipient such that, upon a positive outcome of this check, the compartment may be opened and/or the package removed from the drone so as to allow collection thereof by the user and the completion of the delivery.

Nowadays such solutions have at least two problems which are associated with two possible delivery conditions.

Where a plurality of packages must be delivered to different persons, but to the same geographical location, the drone has to perform an outward journey from and return trip back to the central storage depot for each package which is to be delivered.

Similarly, where a plurality of packages are to be delivered to different persons at geographical locations distributed within a common geographical area, again the drone must make several trips - one for each package - repeating the same travel routes already travelled along for the previous deliveries, resulting in inefficient management of the drone.

### SUMMARY OF THE INVENTION

The problem underlying the present invention is therefore that of ensuring more efficient delivery of packages by means of drones.

The task of a multi-compartment storage container and a drone comprising said container, according to the present invention, is that of allowing the simultaneous distribution of a plurality of packages with the selective delivery of each package specifically to a corresponding predefined recipient, while preventing a user who receives a delivered package from having access to packages intended for different recipients.

In connection with this task an object of the invention is that of proposing a multi-compartment storage container and a drone comprising said container which allows the transportation of packages of different shape and size, resulting in flexible use.

In connection with this task, one object of the invention is that of realizing a multi-compartment storage container and a drone comprising said container which allows the transportation of a variable number of packages.

Yet another object of the present invention is to propose a multi-compartment storage container and a drone comprising said container which, for the same overall volume of groups of packages to be delivered, allows the transportation of a numerous quantity of small-size packages or a less numerous quantity of larger-size packages or a combination of packages of varying sizes and/or volumes.

In general, one object of the present invention is to propose a multi-compartment storage container and a drone comprising said container able to ensure a greater flexibility and efficiency of use of a drone for the automated delivery of packages.

This task, as well as these and other objects which will become clearer below are achieved by a multiple-compartment storage container and a drone comprising said container according to the attached independent claims.

Detailed characteristics of a multi-compartment storage container and a drone comprising said container according to the invention are contained in the dependent claims.

Further characteristic features and advantages will emerge more clearly from the description of a preferred, but non-exclusive embodiment of a multi-compartment storage container and a drone comprising said container according to the invention, with the aid of the drawings provided by way of a non-limiting example in the attached sets of drawings and listed below.

### BRIEF DESCRIPTION OF THE DRAWINGS

FIG. 1 shows a perspective view of a drone according to the present invention having a multi-compartment storage container inserted inside it;

FIG. 2 shows the drone of FIG. 1 with the multi-compartment storage container extracted;

FIG. 4 shows the drone of FIG. 1 with some of the internal compartments of the multi-compartment storage container open;

FIGS. 4a, 4b and 4c show a perspective view of a multi-compartment storage container according to the present invention, with all the internal compartments closed, with some of the internal compartments open and in a partially exploded condition, respectively;

FIG. 5 shows a perspective view of a variant of the drone according to FIG. 1;

FIGS. 6 and 7 show an alternative embodiment of the multi-compartment storage container according to FIGS. 4a, 4b and 4c.

### DETAILED DESCRIPTION

With particular reference to the said figures, 10 denotes overall a multi-compartment storage container for a drone 100 where said multi-compartment storage container 10 comprises, in general:
a housing (11) defining a main compartment (A);
a plurality of separation walls (12a, 12b, 12c) designed to delimit from each other internal compartments B which are contained or can be contained inside the main compartment A;
closing assemblies 13a, 13b each associated with an internal compartment B and able to operated so as to be switched between a locked configuration, in which they prevent access to the internal compartment B, and an unlocked configuration in which they allow access to the internal compartment B;
a control device, not visible in the attached figures, which may be incorporated in the housing 11 or in the drone 100 and which is connected to the closing assemblies 13a, 13b in order to operate them selectively, namely independently of each other or in groups.

The control device may be equipped with an interface configured to receive an identification signal from a user.

The control device may be configured to perform a process comprising:
receiving the identification signal from the interface;
checking if the identification signal is associated with a predefined access authorization; and
unlocking a selected internal compartment B if the predefined access authorization has been previously associated with it or not unlocking any closing assembly 13a, 13b if the outcome of said check is negative.

The identification signal may comprise at least one of the following:
an image of an optical encoding code such as a mono-dimensional or two-dimensional bar code;
an alphanumeric string entered by said user;
biometric data for the recognition of a fingerprint;
biometric data for face recognition.

At least first separation walls 12a of the separation walls 12a, 12b, 12c may be substantially rigid or have a mainly elastic behaviour with a limited elastic deformability, for example of a few millimetres or even a few centimetres during normal conditions of use.

The separation walls 12a can be fixed to the housing 11, directly or by means of further first separation walls 12a, namely being fixed to the latter which may in turn be directly fixed to the housing 11, in order to define the internal compartments B so that they have a substantially fixed geometry.

The separation walls 12a, 12b, 12c may also comprise a lid 12b, which is substantially rigid and associated with each of the internal compartments B where each lid 12b may be hinged with the lid 11 or with one of the first separation walls 12a so as to be operated in order to open and close the respective internal compartment B with which it is associated.

The closing assemblies 13a may be each configured to lock, in the locked configuration, the lid 12b to the housing 11 or to one of the first separation walls 12a.

For example, the closing assemblies 13a may comprise an electric lock, of the type known per se, which comprises a latch electrically operated by means of an electromagnet so that, when the system is not powered, the electric lock is closed.

When the electric lock is powered, typically with 12V, opening is enabled.

A micro-sensor switch may be provided in order to detect the state of the lock, i.e. open or closed.

The housing 11 may comprise an edge 11a which defines a main opening for access to the main compartment A.

The lids 12b may be pivotably mounted on the edge 11a, for example by means of a steel hinge, conventional per se, and the closing assemblies 13a may be configured to lock the lids 12b to the edge 11a, in the locked configuration.

The first separation walls 12a may be each directly fixed to the housing 11 in order to define the internal compartments B in such a way that each of the internal compartments B has a specific opening which opens out opposite one of the lids 12 which is designed to close said opening.

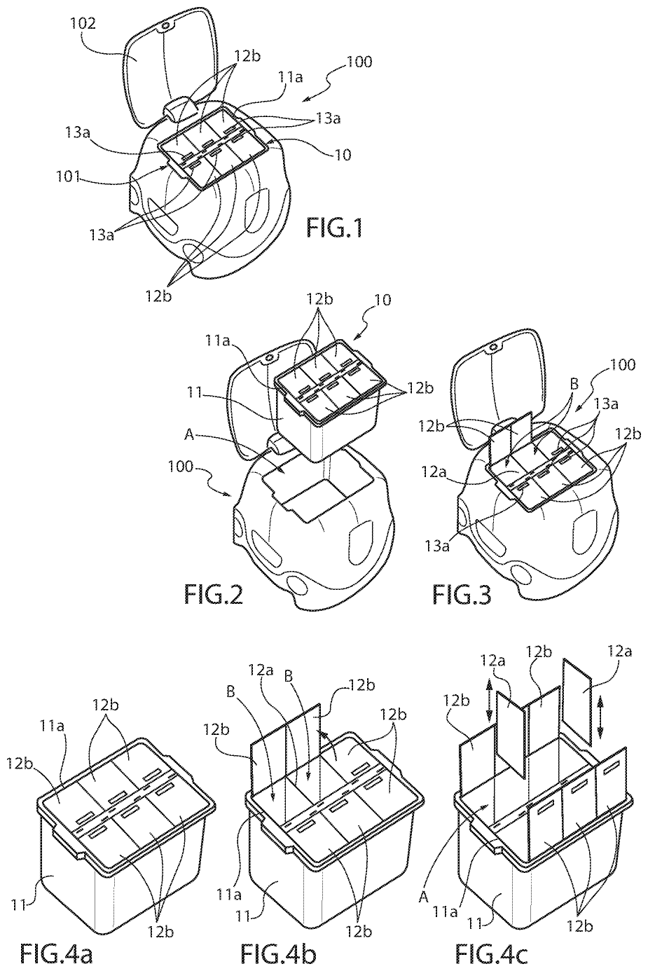

For the purposes of constructional and operational simplicity, the first separation walls 12a may be substantially flat, as shown by way of example in FIGS. 1-4c, 8 and 9.

The housing 11 may have guides 14, which may be linear and which are designed to be engaged by perimetral portions of the first separation walls 12a, in a preferably reversible manner, so as to be able to define the capacity of each of the internal compartments B by means of selective installation of the first separation walls 12a in the main compartment A.

The multi-compartment storage container 10 may, in general, be configured so that the first separation walls 12a, which define a closed internal compartment B, i.e. a compartment whose lid 12b is kept in the closed configuration by the corresponding closing assembly 13a, cannot be separated from the housing 11 except after the opening of said lid 12b.

In other words, the first walls 12a which form one of the internal compartments B cannot be separated from the housing 11 if the lid 12b of this internal compartment B is closed.

In yet other words, in order to remove an internal wall 12a, preferably all the internal compartments which this internal wall 12a delimits must be open.

The separation walls 12a, 12b, 12c may comprise in addition to, or instead of the first walls 12a, second separation walls 12c which can be draped and configured to form a bag suitable for containing a product P to be housed inside the housing 11.

The second walls 12c have an access flap 15 defining an opening for the bag through which products can be inserted into or extracted from the latter.

The closing assemblies 13b may comprise means for closing said opening, such as, by way of a non-limiting example:
means for reciprocally and reversibly joining different portions of the access flap 15 in order to close said opening, such as a zip fastener, and/or
means for narrowing said opening, such as a lace.

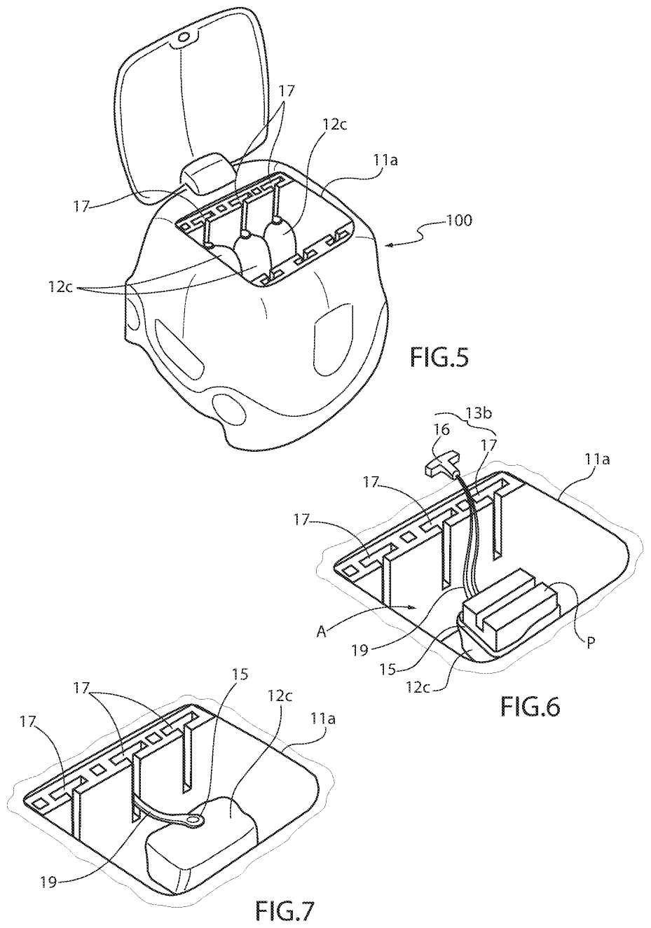

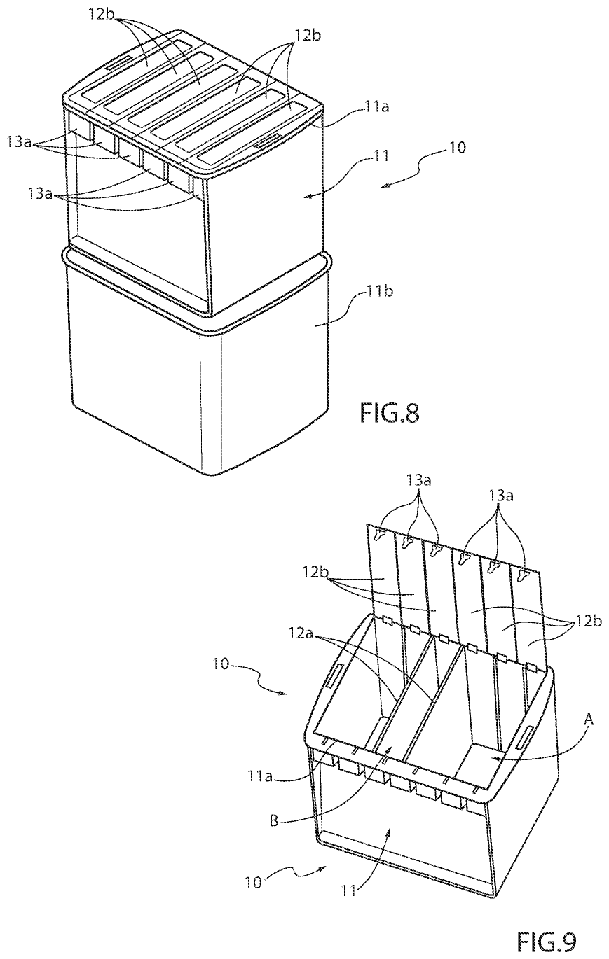

The closing assemblies 13b may, in particular, comprise an anchoring member 16, which is for example T-shaped, as shown by way of example in FIG. 6.

The housing 11 may comprise an anchoring seat 17 designed to be engaged by the anchoring member 16.

The closing assemblies 13b may comprise fastening means which can be operated by the control device so as to be switched between an anchoring configuration in which the anchoring member 16 is locked in the anchoring seat 17 and a free configuration in which the anchoring member 16 can be freely extracted from the anchoring seat 17.

The anchoring member 16 may be in particular fixed to a lace element 18, such as a cable or a ribbon which for example may be inserted inside an eyelet which forms the access edge 15 for closing by means of constriction the opening of the bag so as to prevent access to the internal compartment B delimited by it.

The present invention also relates to a drone 100 comprising a multi-compartment storage container 10 as described above, which may be housed inside a loading seat 101 designed to receive by means of insertion the housing 11 which can be extracted from the loading seat 101.

A cover element 102 may be hinged together with the body of the drone 100 so as to cover, in the closed condition, the loading seat and the multi-compartment storage container 10 which it may house.

The drone 100 preferably is provided with wheels for displacement on the ground and sensors and independent navigation devices for delivery of products housed in the multi-compartment storage container 10.

The multi-compartment storage container 10 may also comprise an outer jacket 11b inside which the housing 11 can be inserted. The outer jacket may be integral with the body of the drone 100 or may be an article separate from the latter.

The invention thus devised may be subject to numerous modifications and variations, all of which fall within the scope of protection of the attached claims.

For example, the attached figures show embodiments which have only first internal walls 12a which are rigid or only second internal walls 12c in the form of a bag; however, it is entirely clear that solutions which envisage the simultaneous use of first and second internal walls 12a and 12c fall within the scope of the present invention.

Moreover, all the details may be replaced by other technically equivalent elements.

Where the operational characteristics and the techniques mentioned are followed by reference numbers or symbols, these reference numbers or symbols have been assigned with the sole purpose of facilitating understanding of the description and the said claims and consequently they do not limit in any way the interpretation of each element which is identified, purely by way of example, by said reference numbers or symbols.

1.-11. (canceled)

12. A multi-compartment storage container for a drone, comprising:
a housing defining a main compartment;
a plurality of separation walls designed to delimit from each other internal compartments which are contained or can be contained in said main compartment;
closing assemblies, each associated with an internal compartment of said internal compartments and able to be operated to switch between a locked configuration, which prevents access to said internal compartment, and an unlocked configuration, which allows access to said internal compartment; and
a control device, connected to said closing assemblies, to operate said closing assemblies selectively and equipped with an interface configured to receive an identification signal from a user; said control device being configured to receive said identification signal from said interface, to check if said identification signal is associated with a predefined access authorization and to unlock a selected internal compartment of said internal compartments when said predefined access authorization has been previously associated with said selected internal compartment.

13. The multi-compartment storage container of claim 12, wherein the identification signal comprises at least one of:
an image of an optical encoding code such as a mono-dimensional or two-dimensional barcode;
an alphanumeric string entered by said user;
biometric data for the recognition of a fingerprint; or
biometric data for face recognition.

14. The multi-compartment storage container of claim 12, wherein at least first separation walls of the plurality of separation walls are substantially rigid and can be fixed to the housing, directly or by means of further separation walls of the first separation walls to define the internal compartments which have a substantially fixed geometry; the plurality of separation walls comprising a lid which is substantially rigid and associated with each of the internal compartments where each of the lids is hinged with the housing or with one of the first separation walls to be operated in order to open and close the respective internal compartment with which it is associated; each of the closing assemblies being configured to lock, in the locked configuration, with the lid to the housing or to one of the first separation walls.

15. The multi-compartment storage container of claim 14, wherein the housing comprises an edge which defines a main opening for access to the main compartment, the lids being pivotably mounted on the edge and the closing assemblies being configured to lock the lids to the edge, in the locked configuration.

16. The multi-compartment storage container of claim 15, wherein each of the first separation walls is directly fixed to the housing to define the internal compartments, so that each of the internal compartments has a specific opening which opens out, opposite one of the lids.

17. The multi-compartment storage container of claims 15, wherein each of the first separation walls is directly fixed to the housing to define the internal compartments, so that each of the internal compartments has a specific opening which opens out opposite one of the lids; wherein the first separation walls are substantially flat and the housing has linear guides configured to be engaged by perimetral portions of the first separation walls in a reversible manner and to define the capacity of each of the internal compartments by means of selective installation of the first separation walls.

18. The multi-compartment storage container of claim 17, wherein the first separation walls, which define a closed internal compartment, cannot be separated from the housing except after the opening of the lid.

19. The multi-compartment storage container of claim 12, wherein the plurality of separation walls comprise second separation walls which can be draped and configured to form a bag suitable for containing a product to be housed in the housing; wherein the second separation walls have an access flap defining an opening for the bag through which products can be inserted into or extracted from; the closing assemblies comprising means for closing the opening.

20. The multi-compartment storage container of claim 19, wherein the closing assemblies comprise:
means for reciprocally and reversibly joining different portions of the access flap (15) in order to close the opening and/or
means for narrowing the opening.

21. The multi-compartment storage container of claim 20, wherein the closing assemblies comprise an anchoring member and the housing comprises an anchoring seat able to be engaged by the anchoring member; the closing assemblies comprising fastening means operable by the control device to be switched between an anchoring configuration in which the anchoring member is locked in the anchoring seat and a free configuration in which the anchoring member is freely extractable from the anchoring seat.

22. A drone comprising a multi-compartment storage container which comprises:
a housing defining a main compartment;
a plurality of separation walls designed to delimit from each other internal compartments which are contained or can be contained in said main compartment;
closing assemblies, each associated with an internal compartment of said internal compartments and able to be operated to switch between a locked configuration, which prevents access to said internal compartment, and an unlocked configuration, which allows access to said internal compartment; and
a control device, connected to said closing assemblies, to operate said closing assemblies selectively and equipped with an interface configured to receive an identification signal from a user; said control device being configured to receive said identification signal from said interface, to check if said identification signal is associated with a predefined access authorization and to unlock a selected internal compartment of said internal compartments when said predefined access authorization has been previously associated with said selected internal compartment, the drone comprising a seat suitable for inserting the housing which can be extracted from the seat.

23. The drone of claim 22, wherein the identification signal comprises at least one of:
an image of an optical encoding code such as a mono-dimensional or two-dimensional barcode;
an alphanumeric string entered by said user;
biometric data for the recognition of a fingerprint; or
biometric data for face recognition.

24. The drone of claim 22, wherein at least first separation walls of the separation walls are substantially rigid and can be fixed to the housing, directly or by means of further separation walls of the first separation walls in order to define the internal compartments which have a substantially fixed geometry; the separation walls comprising a lid which is substantially rigid and associated with each of the internal compartments where each of the lids is hinged with the housing or with one of the first separation walls so as to be operated in order to open and close the respective internal compartment with which it is associated; each of the closing assemblies being configured to lock, in the locked configuration, the lid to the housing or to one of the first separation walls.

25. The drone of claim 24, wherein the housing comprises an edge which defines a main opening for access to the main compartment, the lids being pivotably mounted on the edge and the closing assemblies being configured to lock the lids to the edge, in the locked configuration.

26. The drone of claim 25, wherein each of the first separation walls is directly fixed to the housing in order to define the internal compartments, so that each of the internal compartments has a specific opening which opens out opposite one of the lids.

27. The drone of claim 25, wherein each of the first separation walls is directly fixed to the housing to define the internal compartments, so that each of the internal compartments has a specific opening which opens out opposite one of the lids; wherein the first separation walls are substantially flat and the housing has linear guides configured to be engaged by perimetral portions of the first separation walls in a reversible manner to define the capacity of each of the internal compartments by means of selective installation of the first separation walls.

28. The drone of claim 27, wherein the first separation walls, which define a closed internal compartment cannot be separated from the housing except after the opening of the lid.

29. The drone of claim 22, wherein the separation walls comprise second separation walls which can be draped and configured to form a bag suitable for containing a product to be housed in the housing; wherein the second walls have an access flap defining an opening for the bag through which products can be inserted into or extracted; the closing assemblies comprising means for closing the opening.

30. The drone of claim 29, wherein the closing assemblies comprise:
means for reciprocally and reversibly joining different portions of the access flap in order to close the opening and/or
means for narrowing the opening.

31. The drone of claim 30, wherein the closing assemblies comprise an anchoring member and the housing comprises an anchoring seat able to be engaged by the anchoring member; the closing assemblies comprising fastening means operable by the control device to be switched between an anchoring configuration in which the anchoring member is locked in the anchoring seat and a free configuration in which the anchoring member is freely extractable from the anchoring seat.
